(19) United States
(12) Patent Application Publication
(10) Pub. No.: US 2003/0012301 A1
(43) Pub. Date: Jan. 16, 2003

(54) Method and apparatus for improved cellular telephone communications

(76) Inventor: Harold Walker, Edison, NJ (US)

Correspondence Address: Daniel L Dawes, Myers Dawes & Andras, Suite 1150, 19900 MacArthur Boulevard, Irvine, CA, 92612, US

(21) Appl. No.: 10/181,510

(22) PCT Filed: Jan. 17, 2001
(86) PCT No.: PCT/US01/01578

(51) Int. Cl. H04L 27/12

(52) U.S. Cl. 375/305

(57) ABSTRACT

The invention is a method whereby a digital data bearing signal, comprising a single frequency generated by encoding a nonreturn-to-zero (NRZ) signal so as to cause it to have no frequency spread, is added to the signals presently being transmitted over cellular telephone systems. The signal to be added is comprised of a single frequency, which alternates in phase at coded time intervals. The channels (1, 3) presently in use have bandwidth limits specified by regulatory authorities, which have a small guard space (2, 4) between them. The single frequency signal, which carries data at high data rates, can be added between these channels in a way that will not interfere with the channels in use. Frequency-hopping spread-spectrum is used to further reduce any interaction between channels.

### RELATED APPLICATION

This application is related to U.S. provisional application No. 60/176,646 filed on Jan. 18, 2000.

### BACKGROUND OF INVENTION

1. The Field of the Invention

The invention relates to cellular telephone communication, and in particular to the addition of a frequency-hopping, spread-spectrum radio transmission signal to the presently used narrow band frequency modulated or digitally modulated cellular telephone channels in a manner that causes no interference, while greatly adding to the message carrying capacity of the cellular telecommunications system.

2. Description of the Prior At

The information carrying capacity of the Advanced Mobile Phone System (AMPS), which is a cellular telephone system implemented as a US standard, is limited by the modulation methods in use. Some means must be found to increase this information carrying capacity in order to accommodate the rising need to serve more customers simultaneously and provide other new services.

U.S. Pat. No. 5,930,303 issued to the present inventor makes possible a dramatic increase in data rates by using a new concept of modulation that confines the modulation spectrum to a single frequency, incorporated herein by reference. This modulation method has been given the name ‘VMSK’ or Very Minimum Shift keying.

What is needed is some way in which the increase in data rates in the '303 patent can be employed to improve communication in the Advanced Mobile Phone System.

### BRIEF SUMMARY OF THE INVENTION

The invention is a method whereby a digital data bearing signal, comprising a single frequency generated by encoding a nonreturn-to-zero (NRZ) signal so as to cause it to have no frequency spread, is added to the signals presently being transmitted over cellular telephone systems. The signal to be added is comprised of a single frequency, which alternates in phase at coded time intervals. The channels presently in use have bandwidth limits specified by regulatory authorities, which have a small guard space between them. The single frequency signal, which carries data at high data rates, can be added between these channels in a way that will not interfere with the channels in use. Frequency-hopping spread-spectrum is used to further reduce any interaction between channels.

More particularly, the invention is a method for increasing information carrying capacity in a communications system having allocated channels for communication in a frequency spectrum comprising the steps of VMSK modulating a signal to carrying increased information, and allocating the frequency of the VMSK modulated signal to cause the VMSK modulated signal to occupy the frequency spectrum between allocated channels of the communications system.

The step of VMSK modulating a signal encodes data to be transmitted into a very narrow frequency spectrum. The data to be transmitted is arranged in blocks having a start byte plus an ending byte to indicate the start and completion of a block, which is then transmitted at a frequency different from the last block.

The step of changing the frequency after each block of the blocked VMSK modulation allows the signal to hop or change frequencies periodically in accordance with a preset code, such as a conventional Walsh code.

The method further comprises the step of introducing a dead time period between start and stop bytes to allow data detection circuitry to recover from the frequency hop. The start byte, dead time and stop byte are recognized and rejected by a data receiving device.

The step of block transmitting the VMSK modulated signal with start and stop bytes can be detected to cause a receiver to change or hop in frequency in step with a transmitter in accordance with a preset code.

The invention is alternatively defined as a method for increasing information carrying capacity in a communications system having allocated channels for communication in a frequency spectrum comprising the steps of VMSK modulating a signal to carrying increased information, and inserting a continuously operating VMSK modulated signal into the frequency spectrum between allocated channels of the communications system.

The step of inserting a continuously operating VMSK modulated signal inserts at least two continuously operating VMSK modulated signals and further comprising transmitting blocks of data in a hopping fashion between fixed continuously operating VMSK channels in accordance with a sequencing code.

In the embodiment where there are numerous blocks of data representing a plurality of users of the communications system and the step of transmitting blocks of data separates the users by means of a predetermined sequencing code for each user.

The invention is also an apparatus for performing the above methodology.

While the method has been described for the sake of grammatical fluidity as steps, it is to be expressly understood that the claims are not to be construed as limited in any way by the construction of “means” or “steps” limitations under 35 USC 112, but to be accorded the full scope of the meaning and equivalents of the definition provided by the claims. The invention can be better visualized by turning now to the following drawings wherein like elements are referenced by like numerals.

### BRIEF DESCRIPTION OF FIGURES

FIG. 1 is a graph showing the bandwidth allocation and spectral limits of the AMPS and IS136 cellular system.

FIG. 2 is a simplified block diagram showing a detector for VMSK modulation using a phase locked loop.

FIG. 3 is a simplified block diagram showing a detector for VMSK modulation using a locked oscillator.

FIG. 4 is a simplified block diagram showing a decoder for VMSK modulation.

FIG. 5 is a simplified block diagram showing circuitry to block clock resetting during hop periods.

FIG. 6 is a diagram showing the byte sequence prior to, during and after the hop period.

FIG. 7 is a simplified block diagram showing a minimal group delay filter.

FIG. 8 is a graph showing the spectrum of a VMSK signal.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

It is the purpose of the present invention to greatly increase the information carrying capacity of the Advanced Mobile Phone System (AMPS), which is the cellular telephone system implemented as a US standard, by introducing frequency-hopping, spread-spectrum digital transmissions utilizing the above invention, into the channel edges of the channels presently in use, in such a way as to cause little or no degradation of the present service.

Since the presently used digital modulation methods have a relatively low data transmission rate of 48 kilobits per second, while the method of the referenced patent can easily transmit data at rates of 812 to 1,544 kilobits per second in a spectrum one Hz wide, adding these high data rate channels between the presently used channels will greatly increase the system capacity. This will add many more channels of a digital nature, which can be used for time division multiple access (TDMA) voice, internet data transmission, video conferencing and any other application requiring digital transmission.

Consider first some of the concepts used in the invention. One of the elements of the invention is the present cellular network of analog FM and narrow band digital channels. These channels have a nominal bandwidth of 40 kHz with 30 kHz channel spacing. The adjacent channels are not used so there is a gap between channels in use in a given cell. The FCC specifies that the modulation limit shall be ±12 kHz. Postdeviation filtering reduces or removes any significant signal at ±15 kHz. See, “Wireless Communications-Principles and Practice”, by Rappaport, Prentice Hall, and Code of Federal Regulations 47, Part 22.917. This peak deviation would only occur with a very loud voice peak. Cellular packet data would only reach a fraction of this deviation, probably ±10 kHz. for the J1 Bessel products or at the edges of a QPSK spectrum. Based on a time and use probability, any excursions beyond 15 kHz would be relatively rare.

Frequency-Hopping Spread-Spectrum.

Another concept used in the invention is frequency-hopping spread-spectrum. Frequency-hopping spread-spectrum is a well know technology to those skilled in the art, which changes the frequency of the transmission by a factor of 50 or more times after a brief burst on any one frequency, which usually lasts less that 0.1 second. FCC regulations specify that the signal must not occupy a single frequency for more than 0.4 second in any 20 second period.

Very Minimum Shift Keying (VMSK) Modulation.

Still another concept used in the invention is VMSK modulation which is a modulation method which confines a very high data rate, digital modulation spectrum into a single frequency without the usual frequency spreading common to methods such as BPSK or QPSK. Data rates of 1 Megabit/sec or higher can be transmitted over an existing AMPS cell channel. See, U.S. Pat 5,930,303 (Walker) and patent application Ser. No. 09/612,520 filed Jul. 5, 2000 (Walker). VMSK modulation is the only known modulation method that can be used effectively for the purposes of this invention.

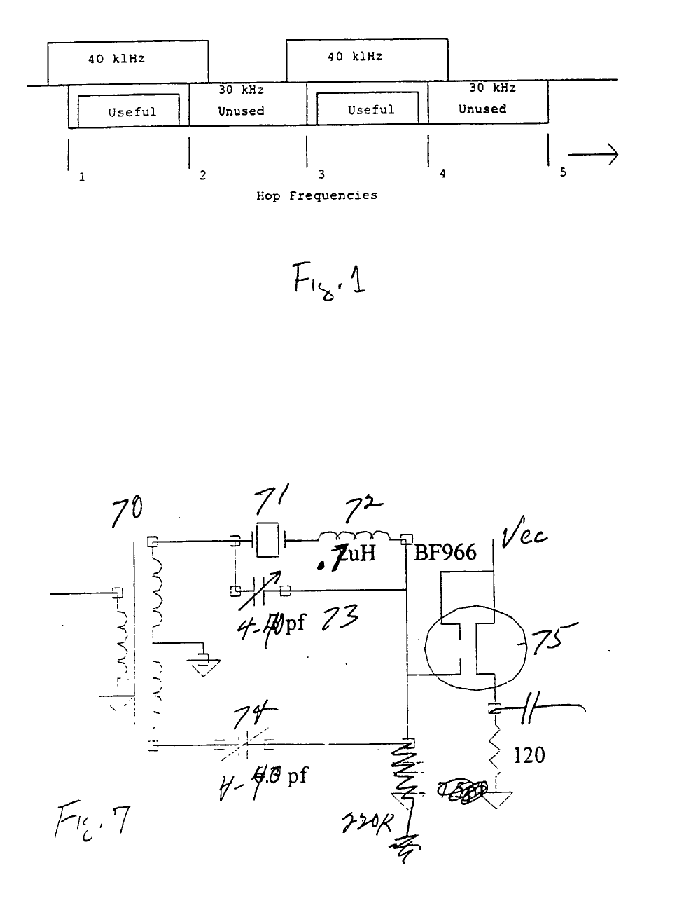

FIG. 1 shows the bandwidth allocation and spectral limits currently mandated for cellular communications. The maximum bandwidth allowed is ±20 kHz, although other portions of the regulations limit this to ±12 Khz. The channel spacing is 30 kHz. Adjacent channels are not used in the same cell.

The channels marked as “useful” in FIG. 1 are at the same cell site as the VMSK frequency-hopping, spread-sprectum transmitter. They may also be separated farther apart, for example using every third channel. The very narrow bandwidth of VMSK modulation makes it possible to sandwich the VMSK modulation between channels. The channels marked “unused” are used by adjacent cell sites. The interference with them will be significantly lower than with the those on the same site. The number of frequency hops causes the hits, if any, to be limited to 1/50 or 1/64 the time on that frequency. Each hit would last less than 1/10 second and most likely be inaudible to an AMPS user.

The IF filters used in FM receivers generally have an exaggerated roll off at the band edges, usually implemented with a Gaussian filter having a slope factor ‘BT’ of 0.3 or 0.5. In addition, a post detection filter, or “window”, is often used to remove any remaining undesired signal. The total rejection of a signal 15 kHz away from the channel center would normally exceed 26 dB.

It is well known to those skilled in the art that a frequency modulation receiver has a capture ratio, usually about 12 dB, which means that any signal weaker than −12 dB would be rejected. Further, any such weak signal would not likely affect the RSSI, or automatic level control of the receiver, especially if it occurred as a very short burst.

It is assumed therefor that a short burst signal falling anywhere at or beyond 15 kHz away from the occupied channel will not cause any interference with that channel.

Thus, it is proposed according to the invention that: a) a VMSK signal be generated carrying digital information at a very high data rate, and b) this signal be frequency hopped using well known frequency hopping techniques so as to fall at the edges of the occupied channels, and c) a receiver using the well known frequency hopping technology be used to recover the VMSK signal.

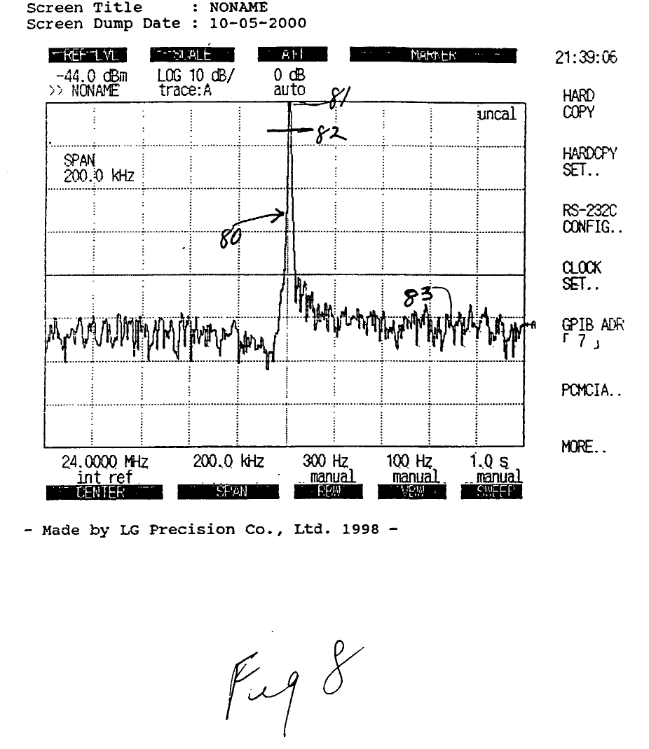

Unlike other modulation methods, the spectrum of the VMSK signal is a single frequency that does not spread, which can be passed through a very narrow band, monocrystal filter such as that shown in FIG. 7, which is described in U.S. patent application Ser. No. 09/612,520 incorporated herein by reference. This filter will reject the adjoining AMPS channel.

For data at 812 kb/s this filter has a 3 dB or half power bandwidth typically of 3 kHz. The VMSK signal, like the FM signal, will hold lock as long as the interference does not exceed −12 dB. Therefore, the chances of interference from an analog FM AMPS signal is slight. By the same logic, the chances of interference from the VMSK frequency-hopping, spread-sprectum signal to the analog FM signal is slight.

A conventional error correcting means can be used in the event of interference, or to improve the error rate for data transmission where extreme accuracy is of importance.

Detection of the VMSK signal depends on locking a reference oscillator to the single frequency of the spectrum, which changes in phase. This signal is one sideband of an encoded signal. A primitive detector for this purpose was shown in

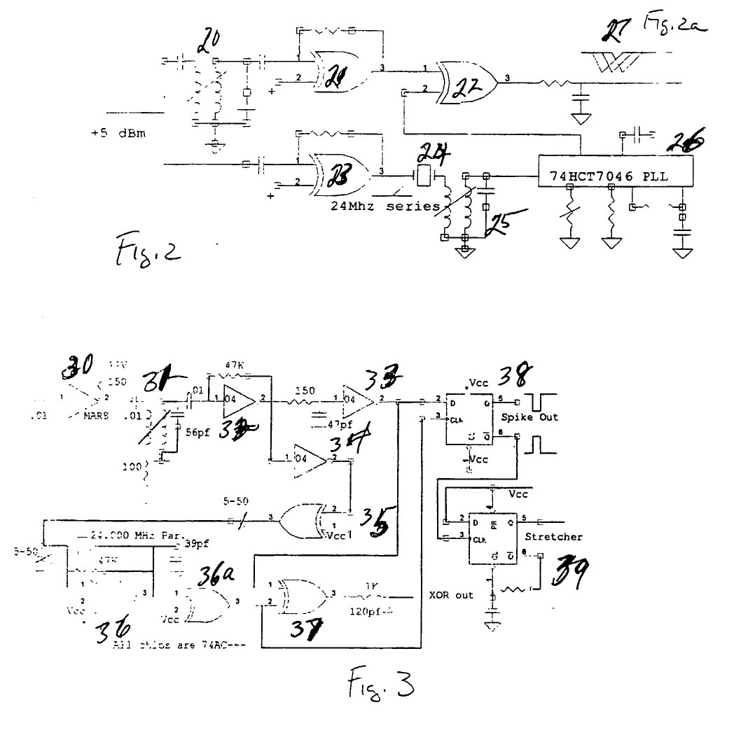

FIG. 6 of U.S. Pat. No. 4,742,532 (Walker) incorporated herein by reference, and is given here in improved form in FIG. 2, and in FIG. 3 in more detail as implemented. The detector requires a phase alternating IF frequency and a stable reference frequency from the PLL or locked oscillator to be usable. Frequency hopping will cause the IF frequency to have phase shifts and possibly slight frequency variations that will result in false data for a short period after the hop until the reference oscillator is stable again, that is locked in frequency and phase to the average phase of the sideband. The loop time constant should be adjusted to enable a fast lock, but not to respond too easily to noise. This locking period is typically 8-16 bit periods.

In the detector shown in FIG. 2, a tunable IF transformer 20 passes the phase alternating signal to an analog amplifier 21 and to a phase detector 22. The signal is also passed via a second path through a CMOS gate used as an analog amplifier 23, a crystal 24 that is caused to ring at the single VMSK sideband frequency and a phase shifting IF transformer 25. The phase locked loop circuit (Harris 74HCT7046), PLL, 26 is used in mode 2, namely locking on zero phase. The phase of the input signals to the phase detector is dependent upon the input winding and tuning of the transformers 21 and 25. The detected output is a series of triangular spikes that occur early or late relative to the data clock. The output 27 shown in inset FIG. 2a occurs when the phases are 180 degrees apart. Provision is made in the decoder to accept positive or negative going spikes (0 or 180 deg.). The phase lock loop circuit 26 operates at slightly higher frequencies than the Harris 74HCT4046 phase lock loop circuit described in U.S. Pat. No. 4,742,532 (Walker), which is the original part number.

FIG. 3 shows an alternate form of the detector of FIG. 2, which uses a locked oscillator 36 instead of a PLL 26 and a D flip flop 38 as a phase detector. Integrated circuits 30, 32, 33, 34, 35 and 36a in FIG. 3 are analog amplifiers to keep the signal at CMOS gate levels. The crystal oscillator 36 is locked to the single frequency of the incoming IF signal. The phase alternating signal is applied to the D input of the D flip flop 38 and to the XOR gate 37. The crystal controlled oscillator reference is applied to the clock input of flip-flop 38 and to the XOR gate 37. The phase differences cause positive or negative pulse outputs from the flip flop 38 which occur early or late with respect to a clock in the decoder circuit. These pulses are too narrow to be used directly and must be stretched in the one shot 39. The XOR phase detector output is still available, but the D flip flop output, which consists of the early late pulses, can offer some advantages.

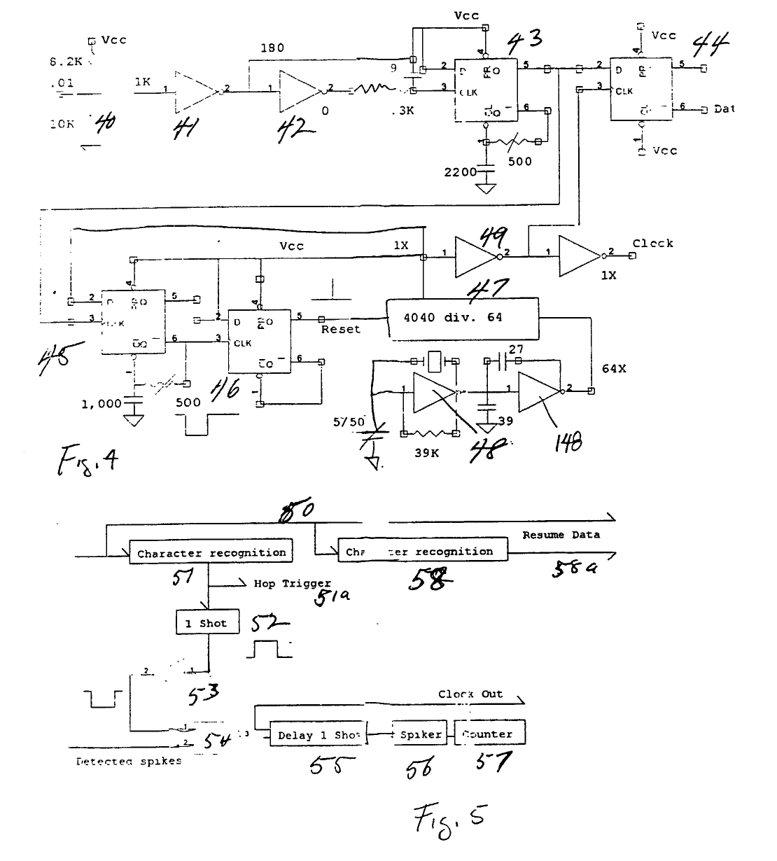

FIG. 4 shows the circuit used to recover VMSK data and restore the clock. The circuit functions as follows. Pulses from the detector circuit in FIG. 2 or FIG. 3 are passed to a voltage level detector 41 which causes a square wave output at CMOS levels as the voltage crosses theshold. The threshold is set by the variable resistor 40. The gate 42 is used to invert the signal if necessary so that pulses in a positive direction are applied to the one shot 43. The pulse width of this one shot is greater than the time difference between early and late pulses so that the D input of the decoder chip 44 is in a high state for a one and a low sate for a zero.

The two lower flip flops 45 and 46 set the clock phase relative to the incoming pulses (early/late). Only early pulses are accepted. A crystal oscillator 48 operating at 64 times the clock rate is divided down to obtain the 1× clock. This divider 47 is reset by the two preceding flip flops 45 and 46. The first is a time delay one shot with a negative going output approximately 1/16 clock period. A smaller delay can be used. The falling voltage output has no effect, but the rising delayed output triggers the second one shot to give a very narrow reset pulse to the frequency divider 47. If the divider 47 has an output which is high when the early pulse arrives, the reset pulse will pass. If it is low, as when the late pulse occurs, there is no reset pulse. The reset pulse can be set very close to the early pulse rise time, setting the clock fall closer to it than to the late pulse. This gives a wider noise immunity range of nearly ⅛ pulse width instead of 1/16 for a 7,8,9 code, which is nearly a 6 dB improvement. The clock oscillator 48 is buffered to provide isolation. A 39 pf capacitor across the buffer 148 holds the oscillator 48 in its fundamental mode, otherwise there is a tendency to go to the 3rd harmonic. The clock reset pulses are locked out if they occur in the wrong half of the clock cycle, a condition that could occur during recovery from a frequency hop. To prevent this, the clock oscillator is permitted to free run while the clock recovers in phase.

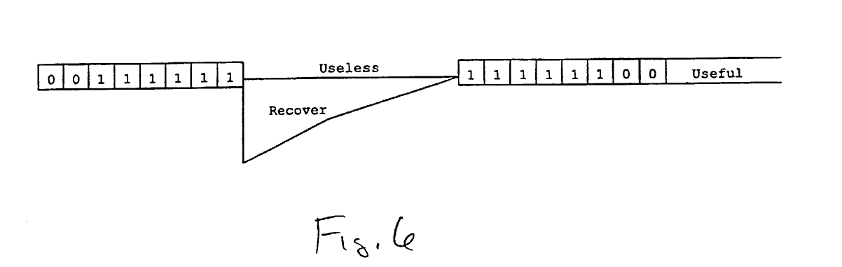

The components shown in FIG. 5 are added to hold off the clock resetting until a specific recovery time is passed. Assume the worst case recovery period is 12 bits. A one shot 52 having a time period equal to 12 bits plus an AND gate 54 are added to the circuit of FIG. 4 to hold off the clock reset triggers. Once the PLL 26 recovers, the one shot 52 returns to its steady state and normal clock recovery occurs.

It is clear that one or two bytes should be added to the data stream to signal a hop and to add some training bits to the data stream after recovery. It is also clear that the clock may have considerable jump or jitter after a hop and this must be buffered or smoothed by additional circuitry. Therefor it is proposed that a trailing byte such as 00111111 be added to each data block transmitted in a hop, that it be used to signal the time for the next hop, and that the reverse byte 11111100 be used as a training or re-synch byte. This assumes that the early pulses from the detector represent digital ones. The VMSK clock is reset by the early pulses, so any digital one after recovery can reset the clock.

Since the data flip flop 44 will continue to function, but pass false bits during the recovery interval, all bits received between the start of the trailing byte and the end of the lead in byte should be rejected in software or pattern recognizing hardware. FIG. 5 shows the circuitry added to FIG. 4 to block clock resetting during hop periods. The circuits 55, 56 and 57 are the same as circuits 45, 46, 47 and 48 of FIG. 4. A timing circuit (not shown) alerts the character recognition chip that a hop is about to occur. The character recognition chip 51 recognizes the hop coding byte and upon recognition of the hopping signal, the one shot 52 blocks the early/late pulses from the decoder by means of the AND gate 54 to prevent them causing random clock resets while the PLL 26 or locked oscillator 36 recover. Upon receiving the second character to restart the acceptance of data, the data processing circuits return to normal functioning. Data between the start of the hopping trigger and the end of the resume trigger will be ignored.

The byte sequence and hop time are shown in the FIG. 6. The recover or blank out period can be shorter than the transmitted time between the trailing and leading bytes as long as the PLL 26 or locked oscillator 36 has recovered in the meantime.

All of the advantages of frequency-hopping, spread-sprectum can be maintained. Time division, or code division multiple access, can be used for multiple users to share the VMSK channel. Using this concept, the capacity of a cell site can be multiplied by using the VMSK frequency hopped channels in a TDMA mode.

The frequency hopping code can be preset. There will be no output from the receiver until a burst on the present frequency is received. When a burst is received, the receiver then has a signal to start hopping according to the preset code. If it is a collision with another code, it will immediately drop out and try again.

The group delay of the filters in the data transmission system is of considerable importance. Ordinarily, this must comply with the Nyquist filter requirement and sampling rate, where a filter, having a group delay equal to the bit period, is required. As additional filters are added in sequence, the group delay increases and the signal output level is reduced. Conventional filters have too much group delay to be used with VMSK modulation.

The use of the mono-crystal filter shown in FIG. 7, or that of a similar low group delay filter, is advantageous to the proper functioning of the present invention. This filter is disclosed in patent filing Ser. No. 09/612,520 of Jul. 5, 2000, along with other filters of a suitable type. No other known filters have the required narrow bandpass and low group delay required. The filter in FIG. 7 operates in a bridge circuit that cancels or alters the capacitance across and within the crystal itself. At resonance, the crystal represents a nearly pure resistance, which can pass a single frequency such as the VMSK spectrum without or with minimal, group delay. The group delay is proportional to the phase change with frequency. If only a single frequency is involved and the filter represents a pure resistance, there is little or no phase change.

It is not necessary to utilize frequency hopping of the VMSK modulated channels when the VMSK channels are added between the normal channels. The spectrum shown in FIG. 8 shows that the interference from a modulated VMSK signal will have minimal effect upon the adjacent channel, since it is below the interference level allowed by the FCC. In lieu of hopping the frequencies, the data can be transmitted in blocks that are hopped across a number of VMSK channels. In the event of cross interference from the normal channels to the VMSK channels, this will cause block errors, which are more easily corrected for by using block error correction codes. Since only one of many blocks will appear in the channel with the interference, this will greatly reduce the error rate for a given user. Multiple users can be accommodated by using blocks of data for each user that are hopped across the VMSK channels in a coded manner.

FIG. 8 shows the VMSK spectrum as transmitted with a typical filter. The signal level is raised by passing it through a limiter and amplifiers to a CMOS chip compatible level, which is 5 volts peak to peak. This peak level is represented by the peak 81 of the single frequency. Certain CMOS chips, such as the 74HC and 74AC series, have a voltage level cross over at 0.5 Vcc (0.5×5.0=2.5 Volts), or 6 dB below the peak 81 as indicated by level 82. The lower noise or interference level 83 is created by sinx/x pulse time differences and is not a desirable part of the signal. As long as the adjacent channel interference does not reach the level 82 after VMSK filtering, the circuits will tend to ignore it.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. A method for increasing information carrying capacity in a communications system having allocated channels for communication in a frequency spectrum comprising:
VMSK modulating a signal to carrying increased information; and
frequency allocating said VMSK modulated signal to cause said VMSK modulated signal to occupy said frequency spectrum between allocated channels of said communications system.

2. The method of claim 1 where said VMSK modulated signal is transmitted intermittently using blocks of data.

3. The method of claim 1 where pulsing said VMSK modulated signal blocks enables said VMSK modulated signal to hop or change frequencies periodically in accordance with a preset code.

4. The method of claim 3 where VMSK modulating a signal encodes data to be transmitted using said VMSK modulated signal by arranging said data in blocks having a start byte plus an ending byte to indicate the start and completion of a frequency hop.

5. The method of claim 4 further comprising introducing a dead time period between start and stop bytes to allow data detection circuitry to recover from said frequency hop.

6. The method of claim 3 where pulsing said VMSK modulated signal is detected by causing a receiver to change or hop in frequency in step with a transmitter in accordance with a preset code.

7. The method of claim 5 where said start byte, dead time and stop byte are recognized and rejected by a data receiving device.

8. A method for increasing information carrying capacity in a communications system having allocated channels for communication in a frequency spectrum comprising:
VMSK modulating a signal to carrying increased information; and
inserting a continuously operating VMSK modulated signal into said frequency spectrum between allocated channels of said communications system.

9. The method of claim 8 where inserting a continuously operating VMSK modulated signal inserts at least two continuously operating VMSK modulated signals and further comprising transmitting blocks of data in a hopping fashion between fixed continuously operating VMSK channels in accordance with a sequencing code.

10. The method of claim 9 in which there are numerous blocks of data representing a number of users of said communications system and where transmitting blocks of data separates said users by means of a predetermined sequencing code for each user.

11. The method of claim 6 in which there are numerous blocks of data representing a number of users of said communications system and where transmitting blocks of data separates said users by means of a preset code for each user.

12. The method of claim 3 in which there are numerous blocks of data representing a number of users of said communications system and where transmitting blocks of data separates said users by means of a preset code for each user.

13. An apparatus for increasing information carrying capacity in a communications system having allocated channels for communication in a frequency spectrum comprising:
a VMSK modulator to carry data at an increased information rate; and
a circuit to pulse said VMSK modulated signal to cause said VMSK modulated signal to occupy said frequency spectrum between allocated channels of said communications system.

13. The apparatus of claim 13 where said circuit to pulse said VMSK modulated signal intermittently pulses said VMSK modulated signal.

14. The apparatus of claim 13 where said circuit to pulse said VMSK modulated signal pulses said VMSK modulated signal to cause said VMSK modulated signal to hop or change frequencies periodically in accordance with a preset code.

15. The apparatus of claim 14 where said VMSK modulator encodes data to be transmitted in said VMSK modulated signal by arranging said data in blocks having a start byte plus an ending byte to indicate the start and completion of a frequency hop.

16. The apparatus of claim 15 further comprising data detection circuitry for receiving said VMSK modulated signal and to detect start and stop bytes, and a timing circuit to introduce a dead time period between start and stop bytes to allow said data detection circuitry to recover from said frequency hop.

17. The apparatus of claim 14 further comprising a transmitter to transmit said VMSK modulated signal and a receiver to detect said pulsed VMSK modulated signal in which said receiver changes or hops in frequency in step with said transmitter in accordance with a preset code.

18. The apparatus of claim 16 where said start byte, dead time and stop byte are recognized and rejected by data detection circuitry.

19. An apparatus for increasing information carrying capacity in a communications system having allocated channels for communication in a frequency spectrum comprising:
a VMSK modulator to carry data at an increased information rate; and
a circuit to insert a continuously operating VMSK modulated signal into said frequency spectrum between allocated channels of said communications system.

20. The apparatus of claim 19 where said circuit to insert a continuously operating VMSK modulated signal inserts at lest two continuously operating VMSK modulated signals and transmits blocks of data in a hopping fashion between fixed continuously operating VMSK channels in accordance with a sequencing code.

21. The apparatus of claim 20 in which there are numerous blocks of data representing a number of users of said communications system and where said circuit transmitting blocks of data separates said users by means of a predetermined sequencing code for each user.

22. The apparatus of claim 14 in which there are numerous blocks of data representing a number of users of said communications system and where said modulator transmitting blocks of data separates said users by means of a preset code for each user.

23. The apparatus of claim 17 in which there are numerous bocks of data representing a number of users of said communications system and where said transmitter transmitting blocks of data separates said users by means of a preset code for each user.
